(19) United States
(12) Patent Application Publication
(10) Pub. No.: US 2025/0329741 A1
(43) Pub. Date: Oct. 23, 2025

(54) BATTERY ELECTRODE AND BATTERY

(71) Applicant: TOYOTA JIDOSHA KABUSHIKI KAISHA, Toyota-shi (JP)

(72) Inventor: Ryuto SAKAMOTO, Okazaki-shi (JP)

(73) Assignee: TOYOTA JIDOSHA KABUSHIKI KAISHA, Toyota-shi (JP)

(21) Appl. No.: 19/079,721

(22) Filed: Mar. 14, 2025

(30) Foreign Application Priority Data
Apr. 22, 2024 (JP) 2024-069164

(51) Int. Cl. H01M 4/62; H01M 4/13; H01M 4/36

(52) U.S. Cl. CPC H01M 4/625; H01M 4/13; H01M 4/366; H01M 4/622

(57) ABSTRACT

The present disclosure provides a battery electrode and a battery capable of reducing resistance. In the battery electrode of the present disclosure, a current collector layer, a carbon coating layer, and an active material layer are laminated in this order. The carbon coating layer comprises a carbon material and a resin. On the surface of the active material layer on the carbon coating layer side, the ratio Rₐ/RSₘ of the arithmetic average roughness Rₐ to the average length RSₘ is 0.10 or more and 1.70 or less. A battery 60 comprises the battery electrode 50 of the present disclosure.

### FIELD

The present disclosure relates to a battery electrode and a battery.

### BACKGROUND

Attempts have been made to improve the adhesion between the current collector layer and the active material layer in battery electrode. For example, PTL 1 discloses an electrode used in an all-solid-state battery, wherein the electrode has a current collector layer, a carbon material layer having an adhesive property, and an active material layer in this order in the thickness direction, and the carbon material layer comprises a carbon material, a dispersant, and a binder.

### CITATION LIST

### Patent Literature

[PTL 1] Japanese Unexamined Patent Publication No. 2023-109290

### SUMMARY

### Technical Problem

In the battery electrode disclosed in PTL 1, the adhesion between the current collector and the active material layer, especially, the adhesion at high temperature (80° C.) has been improved. However the issue was that the resistance increased.

It is an objective of the present disclosure to provide a battery electrode and a battery capable of reducing resistance.

### Solution to Problem

The present disclosure achieves the above objective by the following means.

### Aspect 1

A battery electrode:
wherein a current collector layer, a carbon coating layer, and an active material layer are laminated in this order,
wherein the carbon coating layer comprises a carbon material and a resin, and
wherein on the surface of the active material layer on the carbon coating layer side, the ratio Rₐ/RSₘ of the arithmetic average roughness Rₐ to the average length RSₘ is 0.10 or more and 1.70 or less.

### Aspect 2

The battery electrode according to Aspect 1, wherein the carbon coating layer comprises 10 mass % or more and 15 mass % or less of the carbon material.

### Aspect 3

A battery comprising the battery electrode according to Aspect 1 or 2.

### Aspect 4

The battery according to Aspect 3, wherein the battery is a solid-state battery.

### Advantageous Effects of Invention

According to the present disclosure, on the surface of the active material layer on the carbon coating layer side, by setting the ratio Rₐ/RSₘ of Rₐ to RSₘ within a predetermined range, that is, by adjusting the “sharpness” of the surface irregularities within a predetermined range, it is possible to provide a battery electrode and a battery capable of reducing resistance.

### BRIEF DESCRIPTION OF DRAWINGS

FIG. 1 is a cross-sectional schematic view an example of a battery electrode of the present disclosure.

FIG. 2 is a cross-sectional schematic view showing the carbon coating layer and the active material layer separated from each other with respect to FIG. 1 for explanatory purposes.

FIG. 3 is a cross-sectional schematic view showing an example of a conventional battery electrode.

FIG. 4 is a cross-sectional schematic view showing the carbon coating layer and the active material layer separated from each other with respect to FIG. 3 for explanatory purposes.

FIG. 5 is a cross-sectional schematic view an example of a battery comprising the battery electrode of the present disclosure.

### DESCRIPTION OF EMBODIMENTS

The embodiments of the present disclosure is described in detail below. The present disclosure is not limited to the following embodiments and can be implemented in various forms within the scope of the argument of the present disclosure. In addition, in the description of the drawings, the same reference numerals are assigned to the same elements, and overlapping explanations are omitted.

The battery of the present disclosure may be a liquid battery containing an electrolytic solution as the electrolyte layer, or may be a solid-state battery having a solid electrolyte layer as the electrolyte layer. Note that regarding the present disclosure, “solid-state battery” means a battery which uses at least a solid electrolyte as the electrolyte, and thus, solid-state batteries may use a combination of a solid electrolyte and a liquid electrolyte as the electrolyte. The solid-state battery of the present disclosure may be an all-solid-state battery, i.e., a battery using only a solid electrolyte as the electrolyte.

### <<Battery Electrode>>

In the battery electrode of the present disclosure,
a current collector layer, a carbon coating layer, and an active material layer are laminated in this order,
the carbon coating layer comprises a carbon material and a resin, and
on the surface of the active material layer on the carbon coating layer side, the ratio Rₐ/RSₘ of the arithmetic average roughness Rₐ to the average length RSₘ is 0.10 or more and 1.70 or less.

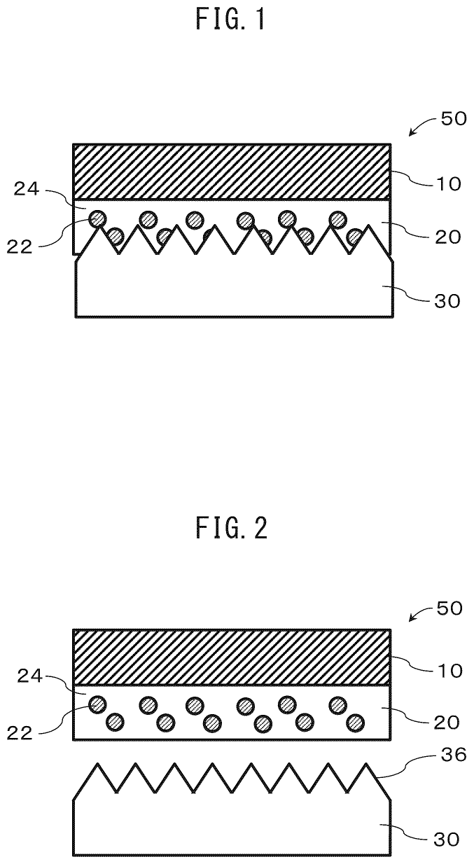

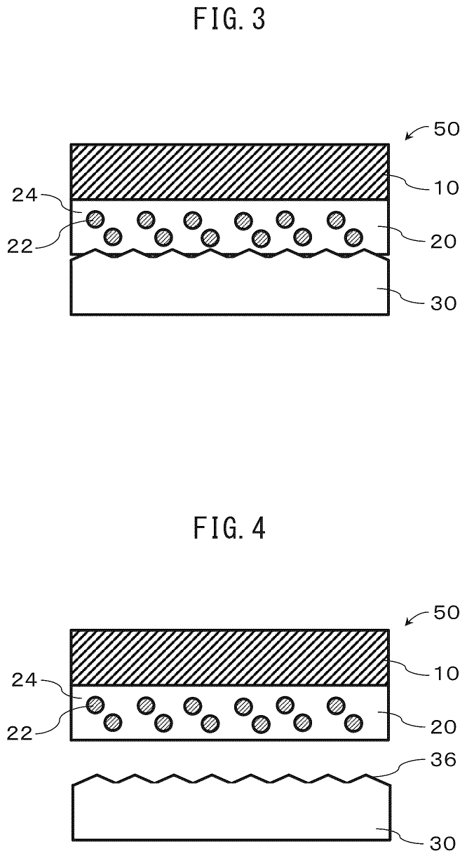

FIG. 1 is a cross-sectional schematic view an example of a battery electrode of the present disclosure. FIG. 2 is a cross-sectional schematic view showing the carbon coating layer and the active material layer separated from each other with respect to FIG. 1 for explanatory purposes. FIG. 3 is a cross-sectional schematic view showing an example of a conventional battery electrode. FIG. 4 is a cross-sectional schematic view showing the carbon coating layer and the active material layer separated from each other with respect to FIG. 3 for explanatory purposes.

In the battery electrode 50, the current collector layer 10, the carbon coating layer 20, and the active material layer 30 are laminated in this order.

Without being bound by theory, in the battery electrode 50 of the present disclosure, as shown in FIGS. 1 and 2, on the surface 36 of the active material layer 30 on the carbon coating layer 20 side, since Rₐ/RSₘ is within a predetermined range, that is, the “sharpness” of the surface irregularities are within a predetermined range, the contact points between the carbon material 22 dispersed in the resin of the carbon coating layer 20 and the active material layer 30 is increased. Therefore, the battery electrode 50 of the present disclosure can reduce its resistance. In particular, in order to improve the peel strength between the carbon coat layer 20 and the active material layer 30, even when the content of the resin 24 is increased, thereby relatively decreasing the content of the carbon material, the resistance can be advantageously reduced.

On the other hand, in the conventional battery electrode 50, as shown in FIGS. 3 and 4, the “sharpness” of the surface 36 irregularities of the active material layer 30 on the carbon coating layer 20 side is not particularly specified, and the contact points between the carbon material 22 of the carbon coating layer 20 and the active material layer 30 were insufficient. Therefore, in the conventional battery electrode 50, its resistance increased.

The each component of the battery electrode of the present disclosure will be described below.

### <Current Collector Layer>

The current collector layer of the battery electrode of the present disclosure may be a negative current collector layer or a positive current collector layer. The negative current collector layer and positive current collector layer are described below.

### <Carbon Coating Layer>

The carbon coating layer comprises a carbon material and a resin. The carbon material ensures conductivity between the current collector layer and the active material layer, thereby reducing the resistance of the battery electrode. The resin imparts adhesion to the carbon coating layer, thereby ensuring the peel strength between the current collector layer and the active material layer (hereinafter, sometimes simply referred to as “peel strength”).

From the viewpoint of reducing the resistance of the battery electrode, the content of the carbon material in the carbon coating layer is preferably 3 mass % or more, 5 mass % or more, 7 mass % or more, or 10 mass % or more. When the content of the carbon material is excessive, the content of the resin decreases relatively. Therefore, from the viewpoint of ensuring the peel strength, the content of the carbon material in the carbon coating layer is preferably 32 mass % or less, 30 mass % or less, 28 mass % or less, 26 mass % or less, 25 mass % or less, 23 mass % or less, 20 mass % or less, 17 mass % or less, 15 mass % or less.

From the viewpoint of ensuring the peel strength, the content of the resin in the carbon coating layer is preferably 70 mass % or more, 72 mass % or more, 7 mass 4% or more, 75 mass % or more, 76 mass % or more, 77 mass % or more, 78 mass % or more, 80 mass % or more, 82 mass % or more, or 83 mass % or more. When the content of the resin is excessive, the relative content of the carbon material decreases relatively. Therefore, from the viewpoint of reducing the resistance of the battery electrode, the content of the resin in the carbon coating layer is preferably 90 mass % or less, 89 mass % or less, 88 mass % or less, 87 mass % or less, 86 mass % or less, or 85 mass % or less.

The carbon material is not particularly limited, and examples thereof include carbon black, carbon fibers, carbon nanotubes (CNT), and carbon nanofibers (CNF). Examples of the carbon black include acetylene black (AB), furnace black (FB), and Ketjen black (KB). The carbon material may be a particulate carbon material or a fibrous carbon material.

The resin is not particularly limited, and may be a thermoplastic resin or a curable resin. Examples thereof include acrylic resins such as polymethyl acrylate, polyethyl acrylate, polypropyl acrylate, polybutyl acrylate, polyhexyl acrylate, poly2-ethylhexyl acrylate, polydecyl acrylate, and polyacrylic acid; methacrylic binders such as polymethyl methacrylate, polyethyl methacrylate, polybutyl methacrylate, poly2-ethylhexyl methacrylate, and polymethacrylic acid; fluoride resins such as polyvinylidene fluoride (PVdF), polyvinylidene fluoride-polyhexafluoropropylene copolymer (PVdF-HFP), polytetrafluoroethylene, and fluorine rubber; and rubber-based resins such as butadiene rubber, hydrogenated butadiene rubber, and styrene-butadiene rubber (SBR), hydrogenated styrene-butadiene rubber, nitrile-butadiene rubber hydrogenated nitrile-butadiene rubber and ethylene propylene rubber.

### <Active Material Layer>

The active material layer of the battery electrode of the present disclosure may be a negative electrode active material layer or a positive electrode active material layer. The negative electrode active material layer and the positive electrode active material layer will be described below.

On the surface of the active material layer on the carbon coating layer side, The ratio Rₐ/RSₘ of the arithmetic average roughness Rₐ to the average length RSₘ is 0.10 or more and 1.70 or less. Rₐ/RSₘ is an index indicating the “sharpness” of surface irregularities, where a relatively large value means that the irregularities are relatively sharp, whereas a relatively small value means that the irregularities are relatively less sharp. The arithmetic average roughness Rₐ and the average length RSₘ conform to JIS B 0601: 2013 (ISO 4287: 1997, Amd. 1: 2009). Rₐ and RSₘ can be calculated, for example, by observing the surface of the active material layer intended for lamination with the carbon coating layer using SEM before laminating the carbon coating layer and the active material layer, and deriving them from the surface profile.

If Rₐ/RSₘ is 0.10 or more, the contact points between the carbon material of the carbon coating layer and the active material layer can be increased. From this viewpoint, Rₐ/RSₘ may be 0.10 or more, 0.30 or more, 0.50 or more, 0.70 or more, 0.90 or more, 1.00 or more, 1.30 or more, or 1.40 or more. If Rₐ/RSₘ is 1.70 or less, it is advantageous for avoiding damage to the surface of the active material layer and/or the carbon coating layer during lamination. From this viewpoint, Rₐ/RSₘ may be 1.65 or less, not 1.60 or less, 1.55 or less, or 1.50 or less.

On the surface of the active material layer on the carbon coating layer side, arithmetic average roughness Rₐ may be 0 3 μm or more, 0.4 μm or more, 0.5 μm or more, 1.0 μm or more, or 2.0 μm or more, and may be 10.0 μm or less, 8.0 μm or less, 6.0 μm or less, 5.0 μm or less, 4.0 μm or less, or 3.0 μm or less.

### <<Battery>>

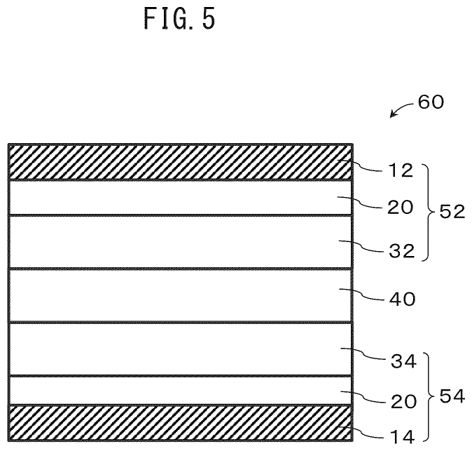

FIG. 5 is a cross-sectional schematic view an example of a battery comprising the battery electrode of the present disclosure. The battery 60 includes a first electrode current collector layer 12, a carbon coating layer 20, a first electrode active material layer 32, an electrolyte layer 40, a second electrode active material layer 34, a carbon coating layer 20, and a second electrode current collector layer 14. The embodiment shown in FIG. 5 is a unit cell, but is not limited thereto.

In FIG. 5, both the first electrode 52, which is composed of the first electrode current collector layer 12, the carbon coating layer 20, and the first electrode active material layer 32, and the second electrode 54, which is composed of the second electrode active material layer 34, the carbon coating layer 20, and the second electrode current collector layer 14, correspond to the battery electrode 50 of the present disclosure. However the present disclosure is not limited thereto, and either one of the first electrode 52 or the second electrode 54 may be the battery electrode 50 of the present disclosure. The combination of the first electrode 52 and the second electrode 54 may be a combination of positive electrode and negative electrode or a combination of negative electrode and positive electrode. The carbon material 22 and the resin 24 of the carbon coating layer 20 are omitted from the description. Further, the surface roughness on the carbon coating layer 20 side for both the first electrode active material layer 32 and the second electrode active material layer 34 is omitted from the depiction.

In FIG. 5, the battery 60 may be a liquid-based battery or a solid-state battery, depending on electrolyte of the electrolyte layer 40.

### <<Method for Manufacturing Battery Electrode and Battery>>

There are no particular limitations to the method for manufacturing the battery electrode of the present disclosure. For example, the following method may be used.

The method for manufacturing the battery electrode of the present disclosure comprises:
providing a current collector layer, a carbon coating layer, and an active material layer;
providing a member having a transfer surface with a surface roughness in which the ratio Rₐ/RSₘ of the arithmetic average roughness Rₐ to the average length RSₘ is 0.10 or more and 1.70 or less, at least in part;
prior to laminating the current collector layer, the carbon coating layer, and the active material layer in this order, pressing the transfer surface of the member against the surface of the active material layer on the carbon coating layer side in advance to transfer the surface roughness.

In an example of the above manufacturing method, the description of “<Battery electrode>>” can be referred to for the current collector layer, the carbon coating layer, and the active material layer.

The surface roughness of the transfer surface of the member can be provided with a desired Rₐ/RSₘ using tools such as a file. By measuring Rₐ and RSₘ of the transfer surface of the member and calculating Rₐ/RSₘ, the calculated value can be used as Rₐ/RSₘ of the active material layer after transfer. Rₐ and RSₘ of the transfer surface of the member may be measured using a standard roughness measuring device, such as a laser surface roughness measuring device, or may be determined by observing the transfer surface with SEM and obtaining its surface profile.

A method for manufacturing the battery comprising the battery electrode of the present disclosure may apply a known methods. For example, in the case of the battery 60 shown in FIG. 5, a method for laminating the first electrode 52 and the second electrode 54 with the electrolyte layer 40 interposed therebetween can be mentioned.

Hereinafter, each configuration of the negative electrode current collector layer, the negative electrode active material layer, the electrolyte layer, the positive electrode active material layer, and the positive electrode current collector layer will be described.

### <Negative Electrode Current Collector Layer>

The materials used for the negative electrode current collector layer is not particularly limited, but commonly used materials for the negative electrode current collector in batteries can be appropriately adopted. Examples of materials used for the negative electrode current collector layer include Cu, Ni, Cr, Au, Pt, Ag, Al, Fe, Ti, Zn, Co, stainless-steel, and carbon sheets, but are not limited thereto. The negative electrode current collector layer may have some coating layer on its surface for the purpose of adjusting resistance.

### <Negative Electrode Active Material Layer>

The negative electrode active material layer includes at least a negative electrode active material, and may optionally further include a solid electrolyte, a conductive aid, and a binder. The negative electrode active material layer may comprise various other additives. The content of each component, such as the negative electrode active material, the solid electrolyte, the conductive aid, and the binder in the negative electrode active material layer may be appropriately determined according to the desired battery performance. For example, considering the entire negative electrode active material layer (the total solid content) as 100 mass %, the content of the negative electrode active material may be 40 mass % or more, 50 mass % or more, or 60 mass % or more, and may be 100 mass % or less, or 90 mass % or less

### (Negative Electrode Active Material)

As the negative electrode active material, various materials having a potential for absorbing and releasing lithium ions (charge and discharge potential) which is lower than that of the positive electrode active material described later may be employed. The materials for the negative electrode active material is not particularly limited, and may be metal lithium, and may be a material capable of absorbing and releasing metal ions such as lithium ions. Examples of materials capable of absorbing and releasing metal ions such as lithium ions may include, but are not limited to, alloy-based negative electrode active materials, carbon materials, or lithium titanate (Li₄Ti₅O₁₂).

Alloy-based negative electrode active material is not particularly limited and may include, for example, Si alloy-based negative electrode active materials or Sn alloy-based negative electrode active materials. Si alloy-based negative electrode active materials include silicon, silicon oxides, silicon carbides, silicon nitrides, or solid solutions thereof. Further, Si alloy-based negative electrode active material may include a metal elements other than silicon, such as Fe, Co, Sb, Bi, Pb, Ni, Cu, Zn, Ge, In, Sn, and Ti. Sn alloy-based negative electrode active materials include tin, tin oxides, tin nitrides, or solid solutions thereof. Further, Sn alloy-based negative electrode active materials may include metal elements other than tin, such as Fe, Co, Sb, Bi, Pb, Ni, Cu, Zn, Ge, In, Ti, and Si.

The carbon material is not particularly limited, and examples thereof include hard carbon, soft carbon, and graphite.

### (Solid Electrolyte)

The material of the solid electrolyte is not particularly limited, and may be, for example, a sulfide solid electrolyte, an oxide solid electrolyte, or a polymer electrolyte.

Examples of the sulfide solid electrolyte include a sulfide-based amorphous solid electrolyte, a sulfide-based crystalline solid electrolyte, or an aldilodite-type solid electrolyte, but are not limited thereto. Specific examples of sulfide solid electrolytes include, Li₂S—P₂S₅-based (such as Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (such as Li₁₃GeP₃Si₆, Li₁₀GeP₂S₁₂), LiI—Li₂S—P₂O₅, LiI—Li₃PO₄—P₂S₅, Li₇₋ₓPS₆₋ₓClₓ; or combinations thereof, but are not limited thereto.

Examples of the oxide solid electrolyte include, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa₂₃₋ₓTiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON); or combinations thereof, but are not limited thereto.

The sulfide solid electrolyte and the oxide solid electrolyte may be glass or crystallized glass (glass ceramics).

Examples of the polymer electrolyte include polyethylene oxide (PEO), polypropylene oxide (PPO), and copolymers thereof, but are not limited thereto.

### (Conductive Aid)

The conductive aid is not particularly limited. Conductive aid may be, for example, vapor grown carbon fiber (VGCF), acetylene black (AB), ketchen black (KB), carbon nanotubes (CNT), or carbon nanofibers (CNF), but is not limited thereto. The forms of the conductive aid may be, for example, particulate or fibrous, and the size thereof is not particularly limited. The conductive aid is not particularly limited, but only one kind thereof may be used alone, and two or more kinds thereof may be used in combination.

### (Binder)

The binder is not particularly limited. The binder may be, for example, materials such as polyvinylidene fluoride (PVdF), butadiene rubber (BR), polytetrafluoroethylene (PTFE), and styrene butadiene rubber (SBR), but are not limited thereto. The binder is not particularly limited, but only one kind thereof may be used alone, and two or more kinds thereof may be used in combination.

### <Electrolyte Layer-Solid Electrolyte Layer>

The battery of the present disclosure may be a solid battery, that is, a battery with a solid electrolyte layer as an electrolyte layer. The solid electrolyte layer includes at least a solid electrolyte, and may include a conductive aid, and a binder, if necessary.

For the solid electrolyte, the conductive aid, and the binder, the description of the above “<negative electrode active material layer>” can be referred to.

### <Electrolyte Layer-Electrolytic Solution>

The battery of the present disclosure may be a liquid-based battery, that is, the battery may have an electrolytic solution, particularly an electrolytic solution retained in a separator layer, as an electrolyte layer.

### (Electrolytic Solution)

The electrolytic solution is not particularly limited, but preferably comprises a supporting salt and a solvent.

The supporting salt (lithium salt) of the electrolytic solution having lithium ion conductivity is not particularly limited, and examples thereof include an inorganic lithium salt and an organic lithium salt. Examples of inorganic lithium salts include LiPF₆, LiBF₄, LiClO₄, and LiAsF₆, but are not limited thereto. Examples of organic lithium salts include LiCF₃SO₃, LiN(CF₃SO₂)₂, LiN(C₂F₅SO₂)₂, LiN(FSO₂)₂, LiC(CF₃SO₂)₃, but are not limited thereto.

The solvent used in the electrolytic solution is not particularly limited, and examples thereof include cyclic carbonate and chain carbonate. Examples of the cyclic carbonate include ethylene carbonate (EC), propylene carbonate (PC), and butylene carbonate (BC), but are not limited thereto. Examples of the chain carbonate include dimethyl carbonate (DMC), diethyl carbonate (DEC), ethyl methyl carbonate (EMC), but are not limited thereto. The electrolytic solution is not particularly limited, but only one kind thereof may be used alone, and two or more kinds thereof may be used in combination.

### (Separator)

The separator is not particularly limited, but commonly used separators for batteries can be appropriately employed. As the separator, for example, nonwoven fabrics such as polyolefin-based, polyamide-based, or polyimide-based can be used.

### <Positive Electrode Active Material Layer>

The positive electrode active material layer includes at least a positive electrode active material, and may optionally further include a solid electrolyte, a conductive aid, and a binder. The positive electrode active material layer may comprise various other additives. The content of each component, such as the positive electrode active material, the solid electrolyte, the conductive aid, and the binder in the positive electrode active material layer may be appropriately determined according to the desired battery performance. For example, considering the entire positive electrode active material layer (the total solid content) as 100 mass %, the content of the positive electrode active material may be 40 mass % or more, 50 mass % or more, or 60 mass % or more, and may be 100 mass % or less, or 90 mass % or less

### (Positive Electrode Active Material)

The material of the positive electrode active material is not particularly limited as long as it is possible to absorb and release lithium ions. As the positive active material may be, for example, lithium cobalt oxide (LiCoO₂), lithium nickel oxide (LiNiO₂), lithium manganese oxide (LiMn₂O₄), lithium nickel-cobalt-manganese oxide (NCM:LiCO_{1/3}Ni_{1/3}Mn_{1/3}O₂), lithium nickel-cobalt-aluminum oxide (LiNi_{0.8}(CoAl)0_{.2}O₂), or heteroelement-substituted Li—Mn spinel represented by the composition Li₁₊ₓMn_{2-x-y}M_{y}O₄ (where M is one or more metal elements selected from Al, Mg, Co, Fe, Ni, and Zn), but is not limited thereto.

The positive electrode active material is not particularly limited, but may have a coating layer. The coating layer is a layer comprising a substance which has lithium ion conductivity, has low reactivity with the positive electrode active material or the solid electrolyte, and can maintain the form of the coating layer without flowing even when in contact with the active material or solid electrolyte. Specific examples of materials constituting the coating layer include LiNbO₃, as well as Li₄Ti₅O₁₂, Li₃PO₄, but are not limited thereto.

The solid electrolyte, the conductive aid, and the binder which can be included in the positive electrode active material layer can be referred to in the description of the above “<negative electrode active material layer>”

### <Positive Electrode Current Collector Layer>

The materials used for the positive electrode current collector layer is not particularly limited, but commonly used materials for the positive electrode current collector in batteries can be appropriately adopted. Examples of materials used for the positive electrode current collector layer include Cu, Ni, Cr, Au, Pt, Ag, Al, Fe, Ti, Zn, Co, and stainless-steel, but are not limited thereto. The positive electrode current collector layer may have some coating layer on its surface for the purpose of adjusting resistance, etc. Also, the positive electrode current collector layer may be a metal foil or a substrate on which the above-mentioned metal is plated or deposited.

### EXAMPLES

### <<Preparation of Samples>>

Each sample was prepared according to the following procedures.

### <Preparation of Positive Electrode Active Material Layer>

A polypropylene container was charged with polyvinylidene fluoride (PVdF), positive electrode active material particles (Li_{1.15}Ni_{1/3}Co_{1/3}Mn_{1/3}O₂ particles coated with lithium-niobate), a sulfide solid electrolyte (Li₂S—P₂S₅-based glass ceramic), and vapor grown carbon fiber (VGCF) (manufactured by Showa Denko K. K). The mixture was stirred with an ultrasonic dispersion device (UH-50, manufactured by SMT) for 30 seconds. The container was then shaken with a shaker (TTM-1, manufactured by SIBATA SCIENTIFIC TECHNOLOGY LTD.) for 3 minutes, and further stirred with an ultrasonic dispersion device for 30 seconds. Further, the container was shaken with a shaker for 3 minutes to obtain a positive electrode mixture.

The obtained positive electrode mixture was applied onto an aluminum foil by the blade coating method using an applicator. Thereafter, the coated positive electrode mixture was naturally dried and dried on a hot plate at 100° C. for 30 minutes to form a positive electrode active material layer on the aluminum foil as a release substrate.

### <Preparation of Negative Electrode Active Material Layer>

A polypropylene container was charged with PVdF, a negative electrode active material particles (LTO particles), and the same sulfide solid electrolyte as mentioned above. The mixture was stirred with an ultrasonic dispersion device for 30 minutes to obtain a negative electrode mixture.

The obtained negative electrode mixture was applied onto a copper foil as a negative electrode current collector by the blade coating method using an applicator. Thereafter, the coated negative electrode mixture was naturally dried and dried on a hot plate at 100° C. for 30 minutes to form a negative electrode active material layer on the copper foil as a negative electrode current collector. Subsequently, the negative electrode mixture was similarly applied on the back surface of the copper foil as a negative electrode current collector and dried to form a negative electrode laminate with a negative electrode active material layer on both surfaces of the copper foil as a negative electrolyte.

### <Preparation of Solid Electrolyte Layer>

A polypropylene container was charged with heptane, butadiene rubber (BR), and a sulfide solid-state electrolyte. The mixture was stirred with an ultrasonic dispersion device for 30 seconds. The container was shaken with a shaker (TTM-1, manufactured by SIBATA SCIENTIFIC TECHNOLOGY LTD.) for 30 minutes, and further stirred with an ultrasonic dispersion device for 30 seconds. After shaking with a shaker for 3 minutes, the obtained mixture was applied onto an aluminum foil by the blade coating method using an applicator. Thereafter, the coated mixture was naturally dried and dried on a hot plate at 100° C. for 30 minutes to form a solid electrolyte layer on the aluminum foil as a substrate.

<Preparation of Carbon-Coated Positive Electrode Current Collector with >

Acetylene black as a conductive aid and an acrylic binder were weighed in the ratios shown in Table 1 so as to be examples and comparative examples. Thereafter, ethyl acetate was added to acetylene black as a conductive aid and an acrylic binder to prepare a carbon coating composition. Next, the carbon coating composition was applied to one side of an aluminum foil to form a film with a thickness of 2 μm, and dried at 100° C. for 1 hour, thereby obtaining a carbon-coated positive electrode current collector (carbon-coated aluminum foil).

### <Preparation of Electrode Body>

The negative electrode laminated body obtained above and the solid electrolyte layer laminated on the release substrate were bonded together in such a manner that the negative electrode active material layer and the solid electrolyte layer were in direct contact. The laminated structure was then pressed at 14.2 kN/cm² (1.6 tf/cm²), and subsequently, the aluminum foil, which was the release substrate for the solid electrolyte layer, was peeled off.

Subsequently, the positive electrode active material layer laminated on the release substrate was further bonded in such a manner that the positive electrode active material layer and the solid electrolyte layer were in direct contact. The laminated structure was then pressed at 14.2 kN/cm² (1.6 tf/cm²) Subsequently, the aluminum foil was peeled off and roll pressing was performed at a linear pressure of 44.5 kN/cm² (5 tf/cm²) to densify the structure. At this time, a stainless steel foil with a predetermined surface roughness was placed between the press roll and the positive active material layer, transferring the surface roughness of the stainless steel foil to the surface of the positive active material layer, thereby adjusting the surface of the positive active material layer to have Rₐ and RSₘ of the examples and comparative examples shown in Table 1.

Thereafter, the positive active material layer was cut so that its area became 70 mm×70 mm, and tape was applied to the side where the negative electrode current collector layer was not exposed, thereby obtaining an electrode laminate.

### <Attachment of Current Collector Foil>

The carbon-coated positive electrode current collector was attached to the entire surface at 140° C. and 5 MPa, ensuring that it did not protrude from the positive electrode active material layer of the electrode laminate. The terminals were then welded and the assembly was vacuum-sealed in a laminate to obtain an evaluation battery.

### <Evaluation Method and Results>>

The evaluation battery was charged in CC-CV charging at 2.95V and 0.3C, followed by discharging to 1.5V. After that, it was charged to 2.17V and then discharged in CC discharging at 5C.

The peel strength between the positive electrode current collector (carbon-coated positive electrode current collector layer) and the positive active material layer was measured in a 900 peel test. Specifically, the electrode laminate was cut into a 10 mm wide strip, and the positive electrode current collector on one side was peeled off. Then, the electrode surface was attached to a stage using double-sided tape, and the positive electrode current collector was clamped. The 90° peel test was then performed.

Rₐ and RSₘ of the surface on the carbon-coated layer side of the positive electrode active material layer were measured in the above-described method and Rₐ/RSₘ ratio was calculated.

The results are shown in Table 1. From Table 1, it can be understood that when the carbon material content in the carbon coating layer is the same, the resistance of the evaluation batteries in the examples, where the Rₐ/RSₘ ratio is within the specified range, is reduced compared to the resistance of the evaluation batteries in the comparative examples, where the Rₐ/RSₘ ratio is outside the specified range. Additionally, Table 1 also shows that as the carbon material content in the carbon coating layer decreases, meaning that the resin content in the carbon coating layer increases, the peel strength increases.

### [Table 1]

TABLE 1

| | Surface roughness of | | | | | | | Resistance | |
|---|---|---|---|---|---|---|---|---|---|
| | positive electrode | | | | | | | ratio | |
| | active material layer | | | Carbon-coated layer | | | | The ratio to | Peel |
| | Ra | RSm | Ra/RSm | carbon material | | resin | | the sample | strength |
| | μm | μm | — | mass % | volume % | mass % | volume % | in Example 1 | N/cm |
| Example1 | 0.5 | 500 | 0.10 | 26 | 17.57 | 74 | 82.43 | 1.00 | 0.3 |
| Example2 | 0.5 | 100 | 0.50 | 26 | 17.57 | 74 | 82.43 | 1.00 | 0.3 |
| Example3 | 1.0 | 150 | 0.67 | 26 | 17.57 | 74 | 82.43 | 1.00 | 0.3 |
| Example4 | 4.0 | 500 | 0.80 | 26 | 17.57 | 74 | 82.43 | 1.00 | 0.3 |
| Example5 | 1.5 | 100 | 1.50 | 26 | 17.57 | 74 | 82.43 | 1.00 | 0.3 |
| Comparative | 0.1 | 500 | 0.02 | 26 | 17.57 | 74 | 82.43 | 1.02 | 0.3 |
| example1 | | | | | | | | | |
| Example6 | 0.5 | 500 | 0.10 | 23 | 14.94 | 77 | 85.06 | 1.00 | 0.6 |
| Example7 | 0.5 | 100 | 0.50 | 23 | 14.94 | 77 | 85.06 | 1.00 | 0.6 |
| Example8 | 1.0 | 150 | 0.67 | 23 | 14.94 | 77 | 85.06 | 1.00 | 0.6 |
| Example9 | 1.5 | 100 | 0.80 | 23 | 14.94 | 77 | 85.06 | 1.00 | 0.6 |
| Example10 | 4.0 | 500 | 1.50 | 23 | 14.94 | 77 | 85.06 | 1.00 | 0.6 |
| Comparative | 0.1 | 500 | 0.02 | 23 | 14.94 | 77 | 85.06 | 1.85 | 0.6 |
| example2 | | | | | | | | | |
| Example11 | 0.5 | 500 | 0.10 | 15 | 8.82 | 85 | 91.18 | 1.00 | 1.5 |
| Example12 | 0.5 | 100 | 0.50 | 15 | 8.82 | 85 | 91.18 | 1.00 | 1.5 |
| Example13 | 1.0 | 150 | 0.67 | 15 | 8.82 | 85 | 91.18 | 1.00 | 1.5 |
| Example14 | 1.5 | 100 | 0.80 | 15 | 8.82 | 85 | 91.18 | 1.00 | 1.5 |
| Example15 | 4.0 | 500 | 1.50 | 15 | 8.82 | 85 | 91.18 | 1.00 | 1.5 |
| Comparative | 0.1 | 500 | 0.02 | 15 | 8.82 | 85 | 91.18 | 1.85 | 1.5 |
| example3 | | | | | | | | | |
| Example16 | 0.5 | 500 | 0.10 | 10 | 5.56 | 90 | 94.44 | 1.15 | 2.0 |
| Example17 | 0.5 | 100 | 0.50 | 10 | 5.56 | 90 | 94.44 | 1.15 | 2.0 |
| Example18 | 1.0 | 150 | 0.67 | 10 | 5.56 | 90 | 94.44 | 1.15 | 2.0 |
| Example19 | 1.5 | 100 | 0.80 | 10 | 5.56 | 90 | 94.44 | 1.15 | 2.0 |
| Example20 | 4.0 | 500 | 1.50 | 10 | 5.56 | 90 | 94.44 | 1.15 | 2.0 |
| Example21 | 1.0 | 150 | 0.67 | 30 | 21.43 | 70 | 78.57 | 1.07 | 0.1 |

### REFERENCE SIGNS LIST

10 Current collector layer
12 First electrode current collector layer
14 Second electrode current collector layer
20 Carbon coating layer
22 Carbon material
24 Resin
30 Active material layer
32 First electrode active material layer
34 Second electrode active material layer
40 Electrolyte layer
50 Battery electrode
60 Battery

1. A battery electrode:
wherein a current collector layer, a carbon coating layer, and an active material layer are laminated in this order,
wherein the carbon coating layer comprises a carbon material and a resin, and
wherein on the surface of the active material layer on the carbon coating layer side, the ratio Rₐ/RSₘ of the arithmetic average roughness Rₐ to the average length RSₘ is 0.10 or more and 1.70 or less.

2. The battery electrode according to claim 1, wherein the carbon coating layer comprises 10 mass % or more and 15 mass % or less of the carbon material.

3. A battery comprising the battery electrode according to claim 1.

4. The battery according to claim 3, wherein the battery is a solid-state battery.
